(19) United States
(12) Patent Application Publication
(10) Pub. No.: US 2002/0163629 A1
(43) Pub. Date: Nov. 7, 2002

(54) Methods and apparatus employing an index matching medium

(76) Inventors: Michael Switkes, Somerville, MA (US); Mordechai Rothschild, Newton, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/140,130

(22) Filed: May 7, 2002

Related U.S. Application Data
(60) Provisional application No. 60/289,217, filed on May 7, 2001.

(51) Int. Cl. G03B 27/42; G02B 5/24; G02B 1/06; G02B 3/12; G03B 11/00; G03B 27/00

(52) U.S. Cl. 355/53; 359/886; 359/665; 252/582; 355/18

(57) ABSTRACT

A perfluoropolyether (PFPE) index matching medium. The medium may be used with electromagnetic radiation having a wavelength below 220 nm. The medium may be used between two optical surfaces or between an optical surface and an object. The medium may be used as an immersion fluid in an immersion lithographic system.

### RELATED APPLICATIONS

This application claims priority from U.S. provisional application No. 60/289,217 by Switkes, et al., filed May 7, 2001, entitled, “Immersion system at wavelengths below 220 nm,” the subject matter of which is hereby incorporated by reference.

### STATEMENT OF GOVERNMENT SPONSORED R&D

This invention was made with government support under contract no. F 19628-00-C-0002. The government may have certain rights in the invention.

### BACKGROUND OF THE INVENTION

1. Field of Invention

This invention relates to optical systems and apparatus employing index matching media. More particularly, the invention relates optical systems and apparatus employing index matching media for use with short-wavelength electromagnetic radiation.

2. Background

In both collection and projection optical systems, frequently there is a desire to resolve high-resolution patterns (e.g., images, scanning spots, interference patterns). Examples of such optical systems are photolithograhic systems. In photolithographic systems, light is projected onto a resist for the purpose of patterning an electronic device. Photolithographic systems have been a mainstay of semiconductor device patterning for the last three decades and are expected to continue in that role down to 70 nm resolution (i.e., 70 nm feature size) and possibly beyond.

The resolution (r₀) of a photolithographic system having a given lithographic constant k₁, is given by the equation

r₀=k₁λ/NA (1)

where λ is the operational wavelength, and numerical aperture (NA) is given by the equation

NA=n sin θ₀ (2)

Angle θ₀ is the angular semi-aperture of the system, and n is the index of the material filling the space between the system and the substrate to be patterned.

Conventional methods of resolution improvement have lead to three trends in the photolithographic technology: (1) reduction in wavelength λ from mercury g-line (436 nm) to the 193 nm excimer laser, and further to 157 nm and the still developing extreme-ultraviolet (EUV) wavelengths; (2) implementation of resolution enhancement techniques (RETs) such as phase-shifting masks, and off-axis illumination have lead to a reduction in the lithographic constant k₁ from ˜0.6 to values approaching 0.4; and (3) increases in the numerical aperture (NA) via improvements in optical designs, manufacturing techniques, and metrology. Such improvements have lead to increases in NA from approximately 0.35 to greater than 0.7, with 0.8 expected in the next few years. However, as can be seen in Equation (2), for free-space optical systems (i.e., n=1), there is a theoretical limit bounding NA to values of one or less.

Immersion lithography provides another possibility for increasing the NA of an optical system, such as a lithographic system. In immersion lithography, a substrate is immersed in a high-index fluid (also referred to as an immersion medium), such that the space between a final optical element and the substrate is filled with a high-index fluid (i.e., n>1). Accordingly, immersion provides the possibility of increasing resolution beyond the free-space theoretical limit of one. To date, immersion lithography has not been implemented in commercial semiconductor processing partly because improvements in resolution by conventional methods have been possible, but also partly because of a lack of immersion fluids that have appropriate optical transmission characteristics and chemical compatibility with lithographic systems.

The desire to develop immersion systems is growing more acute because the ability to achieve resolution improvements via conventional means, such as wavelength reduction, appears to be increasingly difficult, particularly at wavelengths below 220 nm. In addition, with NAs produced by free-space lithographic methods approaching the theoretical limit, progress using conventional methods is bounded. Accordingly, there is a need for immersion media that are compatible with lithographic systems, particularly those systems having an operative wavelength below 220 nm. It should be understood that the phrase “immersion medium” is used herein to identify an “index-matching medium” used to immerse an object (e.g., a substrate).

### SUMMARY OF THE INVENTION

Aspects of the invention include optical systems using perfluoropolyethers (PFPEs) as index matching media. In some aspects of the invention, an index matching medium is used to immerse an object (e.g., a substrate in a lithographic system), and in other aspects the PFPE is used as an index matching medium between two optical surfaces of an arbitrary optical system. Further aspects of the invention include systems for performing immersion lithography at wavelengths below 220 nm, e.g., 193 and 157 nm.

A first aspect of the invention is an optical system for transmitting light, comprising an optical surface, and a PFPE medium contacting at least a portion of the optical surface, the PFPE medium configured to transmit at least a portion of the transmitted light. The optical system may further comprise a second optical surface, the PFPE medium contacting at least a portion of the second optical surface. The optical system may be a collection optical system or a projection optical system.

A second aspect of the invention is an immersion lithographic system for projecting light having a wavelength less than 220 nanometers onto a resist covering at least a portion of a substrate, comprising an optical surface, and an index matching medium contacting at least a portion of the optical surface, the index matching medium configured to transmit at least a portion of the light. In some embodiments, the index matching medium is characterized by a transmission of the light, the transmission remaining substantially constant during an exposure of a substrate. The medium may be substantially transparent to the light. In some embodiments of the second aspect, the liquid is a PFPE. For example, the liquid may be Fomblin Y®, or Fomblin Z®.

A third aspect of the invention is a method of transmitting light, comprising an act of transmitting light through a PFPE medium. In some embodiments, the light has a wavelength less than 220 nm. In other embodiments, the method further comprises transmitting the light through at least a portion of a first optical surface, wherein the first optical surface is in contact with the PFPE medium. In still other embodiments, the method further comprises transmitting the light through at least a portion of a second optical surface, wherein the second optical surface is in contact with the PFPE medium. The method may include projecting the light onto a photosensitive material.

### BRIEF DESCRIPTION OF THE DRAWINGS

Illustrative, non-limiting embodiments of aspects of the present invention will be described by way of example with reference to the accompanying drawings, in which:

FIG. 1A is a schematic drawing of a first embodiment of an optical system illustrating aspects of the present invention;

FIG. 1B is a schematic drawing of a second embodiment of an optical system illustrating aspects of the present invention;

FIGS. 2A is a schematic illustration of a first class of PFPEs appropriate for use with the present invention;

FIGS. 2B is a schematic illustration of a second class of PFPEs appropriate for use with the present invention;

FIGS. 2C is a schematic illustration of a third class of PFPEs appropriate for use with the present invention;

FIG. 3 is a graphical representation of absorbance of the first class of PFPEs as a function of wavelength;

FIG. 4A is a graphical representation of transmission of a sample of the first class of PFPEs as a function of wavelength for cumulative dose levels of 1, 10 and 100 J/cm²;

FIG. 4B is a graphical representation of transmission of a sample of the second class of PFPEs as a function of wavelength for cumulative dose levels of 1, 10 and 100 J/cm²;

FIG. 5 is a schematic diagram of one example of an embodiment of a projection lithographic system according to aspects of the present invention; and

FIG. 6 is a schematic view of a system for determining the ability of a given index matching medium to operate with a scanner lithographic system operating at a given scan speed.

### DETAILED DESCRIPTION OF THE INVENTION

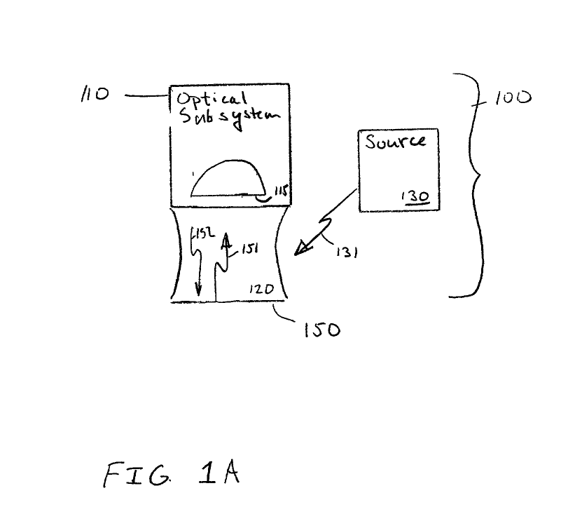

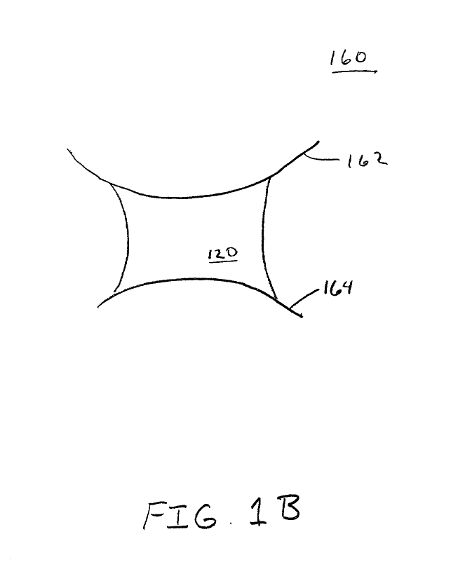

FIG. 1A is a schematic drawing of a first embodiment of an optical system 100 illustrating aspects of the present invention. Optical system 100 includes an optical subsystem 110 and an index matching medium 120. System 100 may transmit light projected onto object 150, and/or collect light from object 150. Accordingly, optical subsystem 110 may be a projection optical system (e.g., a photolighographic system) or a collection optical system (e.g., a microscope).

Light 152 projected from system 100 can be any known type of light capable of being transmitted by index matching medium 120 (e.g., light of any transmitted wavelength, light that is coherent or incoherent, light that is pulsed or continuous). Light 151 provided by object 150 can be any known type of light capable of being transmitted by index matching medium 120, and may include redirected light 131 from a source 130 (e.g., light scattered by object 150) or light generated by object 150 (e.g., object 150 is self-luminescent).

Optical surface 115 (also referred to as a “final optical surface”) is the optical surface of system 100 that is most proximate object 150. Final optical surface 115 can be convex, concave, plano, diffractive or any other known optical surface. Index matching medium 120 fills a space between final optical surface 115 of optical subsystem 110, and object 150, such that index matching medium 120 makes contact with at least a portion of optical surface 115 and at least a portion of object 150, and continuously fills the space between surface 115 and object 150. Accordingly, at least a portion of the light transmitted by system 100 is transmitted by index matching medium 120.

According to aspects of the present invention, index matching medium 120, is used as immersion medium, and is substantially transparent at one or more wavelengths or wavelength bands below 220 nm. Particularly useful materials are materials that are transparent at wavelengths of light commonly used for lithography, for example wavelengths at or about 193 or 157 m. Preferably, index matching medium 120 is substantially transparent to light at the operative wavelengths of system 100, and the transmission of the material remains constant during a single exposure to the light. More preferably medium 120 does not degrade with exposure to radiation, e.g., the material does not become increasingly opaque with increasing exposure. In practice, medium 120 will likely undergo some degradation and may be replaced from time to time, either as a whole or by a continuous stream of fresh medium 120.

Preferably, medium 120 provides low or substantially zero scattering of light projected through said medium. The amount of scattering that can be tolerated depends on the specific system with which medium 120 is used. Scattering can be determined by projecting a collimated beam, having a known beam profile, through a portion of a medium and comparing the beam profile to the known beam profile.

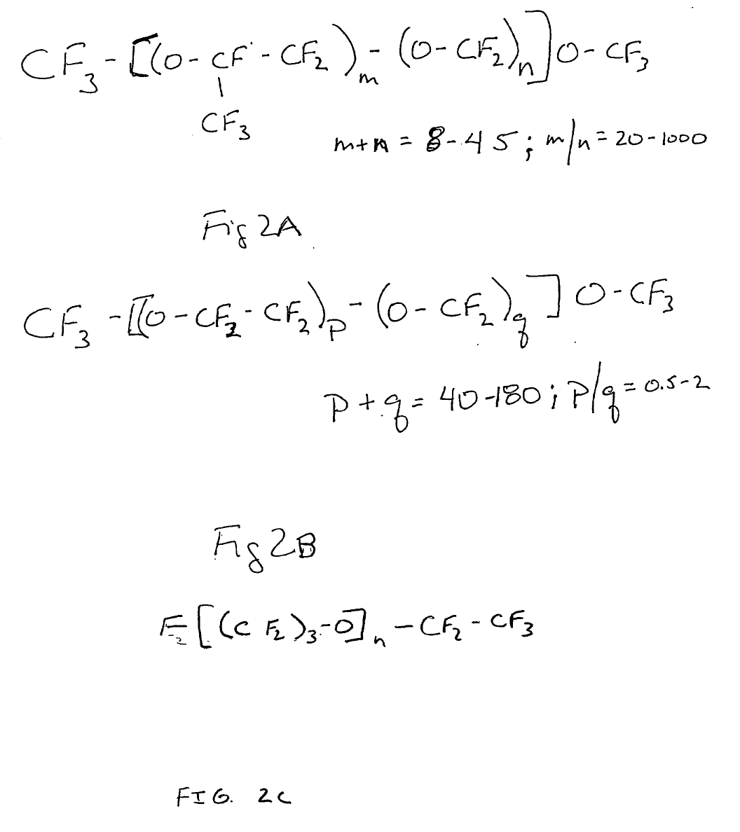

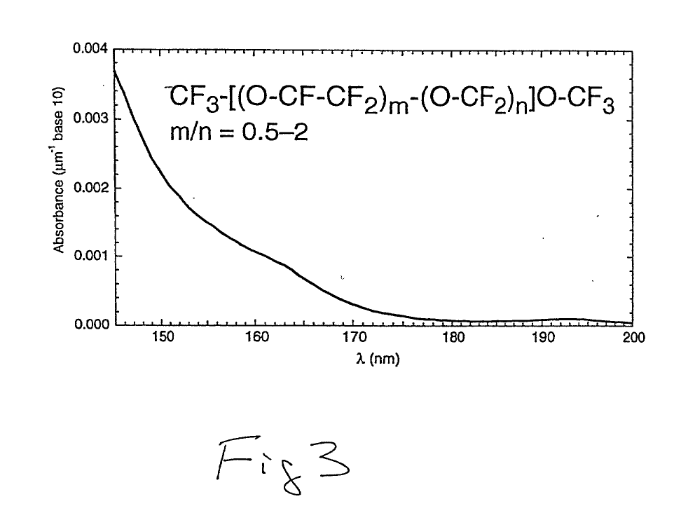

In one embodiment of system 100 according to at least some aspects of the present invention, index matching medium 120 is any liquid that transmits light at the operative wavelengths of system 100, and that is capable of maintaining optical contact with at least a portion of final optic surface 115 and object 150. For example, transmission may be measured using any known method of measuring transmission. It is to be understood that the adequate transmission is determined by the specific application with which a medium is used. Examples of immersion materials appropriate for use with this invention include perfluoropolyethers (PFPE). FIGS. 2a, 2b, and 2c are schematic illustrations of three examples of classes of PFPE structures appropriate for use with the present invention. The classes of PFPEs illustrated in FIGS. 2a, 2b, 2c are available under the trademarks Fomblin Y®, Fomblin Z®, Demnum™ respectively. Fomblin Y®, Fomblin Z®, Demnum™ have molecular weight ranges of 1,500-7,250 AMUs (e.g., Fomblin® Y-18), 4,000-19,000 AMUs (e.g., Fomblin Z® Z-25), and 2,700-8,400 AMUs (e.g., Demnum™ S20 or Demnum™ S200), respectively. Demnum™, Fomblin Y®, and Fomblin Z® are available from the Ausimont Corporation of Thorofare, N.J. Demnum™ is available from Daikin Corporation of Osaka, Japan. Other examples of PFPE appropriate for use with the present invention are Krytox® available from Dupont Corporation of Wilmington, Del. and Galden® available from the Ausimont Corporation. It is to be understood that in some cases side groups may degrade transmission performance of PFPEs; for example, in some embodiments, it may be desirable to avoid side groups containing other than carbon-fluorine or carbon-oxygen bonds.

Referring again to FIG. 1A, index matching medium 120 may be a liquid which coats object 150 and forms a continuous optical contact (i.e., a meniscus) between object 150 and final optical surface 115. Alternatively, object 150 and the final optical surface 115 could be coated with an index matching medium 120 that is resilient, such as a gel. A gel index matching medium 120 can be brought into optical contact with object 150 and final optical surface 115 with pressure to form a continuous optical contact.

Object 150 may be chemically or physically cleaned of index matching medium 120 before subsequent processing of object 150. Alternatively, in lithographic systems (e.g., lithographic system 500 discussed with reference to FIG. 5 below), the index matching material 120 may function as a resist material; such a resist would be deposited on the substrate (e.g., substrate 550 in FIG. 5), and have sufficient resilience to make continuous optical contact directly with a final optical surface 115 that is brought into contact with the resist. An index matching material 120 that functions as a resist may eliminate the need for a separate index matching medium between the resist and the final optical surface 115, providing the advantage of eliminating extra processing involved with having a separate resist and index matching medium.

FIG. 1B is a schematic illustration of two surfaces 162, 165 of an optical system 160 (e.g., optical subsystem 100 in FIG. 1) illustrating aspects of the present invention. Optical system 160 may include any number of optical surfaces in addition to optical surfaces 162, 164. Surfaces 162 and 164 can be convex, concave, plano, diffractive or any other known optical shape. Index matching medium 120 fills a space between surfaces 162 and 164, such that index matching medium 120 makes optical contact with at least a portion of optical surface 162 and at least a portion of object 164, and continuously fills a space between surfaces 162 and 164.

FIG. 3 is a graphical representation of absorbance of Fomblin Z® as a function of wavelength. FIG. 3 illustrates that polyfluorinated polyethers (PFPE), are substantially transparent at wavelengths below 200 nm and in particular, at both 193 and 157 nm. Fomblin Z® has an absorbance α on the order of 10⁻³ μm⁻¹ at 157 nm. Accordingly, Fomblin Z® provides 90% transmission at a working distance of 50 μm.

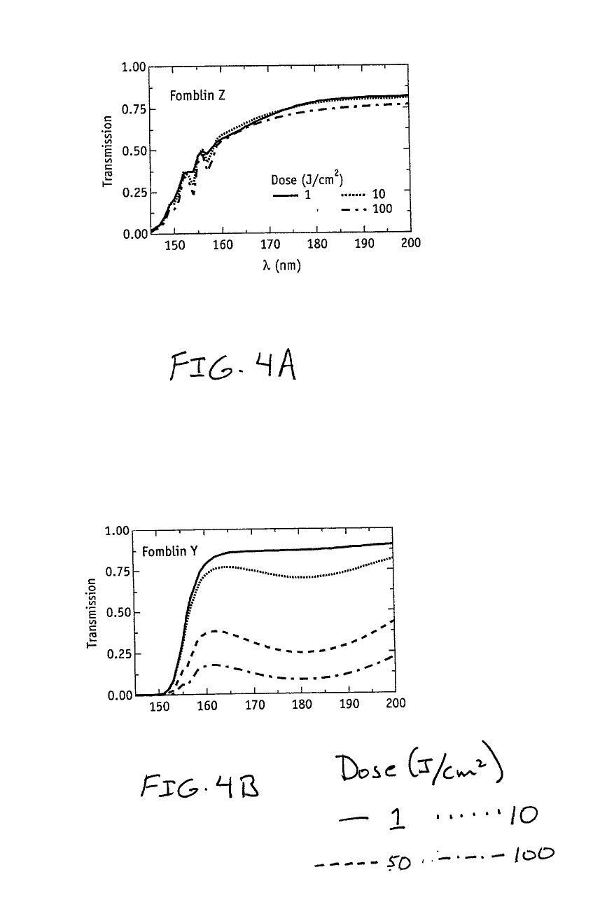

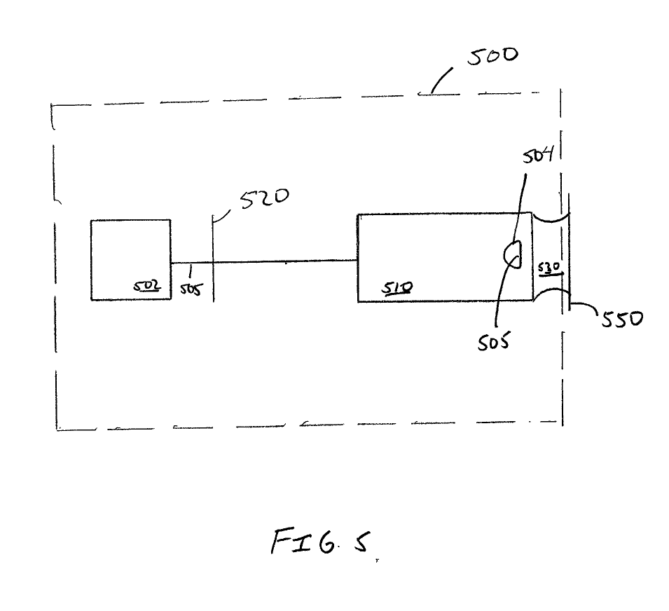

FIG. 4A is a graphical representation of transmission of a sample of Fomblin Z® as a function of wavelength for cumulative dose levels of 1, 10 and 100 J/cm². The sample included a layer of Fomblin Z® having a thickness of 150 μm. The sample was located between (i.e., sandwiched between) two CaF₂ windows, each window having a thickness of 2 mm.

The cumulative dose levels illustrated in FIG. 4A were achieved using pulses having a fluence of 0.3 mJ cm ² pulse⁻¹. FIG. 4A illustrates that Fomblin Z® is substantially resistant to laser damage at wavelengths greater than 157 nm. For a cumulative dose of 100 J cm⁻² at a fluence of 0.3 mJ cm⁻² pulse⁻¹, the transmission of the sample at 157 nm drops only 17%. These data indicate that several thousand pulses could be transmitted by an optical system, using Fomblin Z® as an index matching medium, with less than 1% change in transmission. For example, the data illustrate that several thousand substrates could be exposed using projection system 500 in FIG. 5 below, where Fomblin Z® is used as an index matching medium 634. It should be noted however that not all PFPEs share the same degree of damage resistance; for example, the 157 nm transmission of a 150 μm layer of Fomblin Y®, while initially as high as Fomblin Z®, decreases by 80% after a cumulative dose of 100 J cm⁻². FIG. 4B is a graphical representation of transmission of a sample of Fomblin Y® as a function of wavelength for cumulative dose levels of 1, 10 and 100 J/cm². PFPEs, such as Fomblin Y®, that are damaged more readily may be replaced more frequently to maintain sufficient transmission.

FIG. 5 is a schematic diagram of one example of an embodiment of a projection system 500 according to aspects of the present invention. Projection system 500 comprises an electromagnetic radiation source 502, an imaging system 510, and an index matching medium 530. System 500 may be any suitable lithographic system, such as a conventional stepper or a scanner lithographic system. Preferably, system 500 has an imaging system 510 capable of accommodating the NA arising from having index matching medium 530 between optical system 530 and a photosensitive material 550.

Source 502 generates an input beam 505. In some embodiments, source 502 generates at least quasi-coherent illumination. For example, source 502 can include a lamp or a laser light source. In some embodiments, source 502 generates light at or below 220 nm. In one embodiment, source 502 is an excimer laser.

Imaging system 510 images a mask 520 onto photosensitive material 550. Imaging system 510 includes a final optic 504 having a final optical surface 505. Final optic is any optic having optical power and suitable for imaging mask 520. In some embodiments, final optic has a plano final optical surface 505. Photosensitive material 550 can be any known photosensitive material, e.g., a photographic film or a photolithographic resist on a semiconductor substrate. Mask 520 can be any suitable known mask for use with light source module 502, and imaging module 510.

Index matching medium 530 fills a space between the final optical surface 505 and material 550. Index matching medium 530 is in optical contact with at least a portion of the final optical surface 505 and at least a portion of a surface of material 550, and continuously fills a space between final surface 505 and object 550. Index matching medium 530 is any suitable medium transparent at the operative wavelength of system 500. Index matching medium 530 may be any index matching medium 120 as described above with reference to FIG. 1 and FIGS. 2a-2c. For example, index matching medium may be a PFPE.

Although the description of aspects of the present invention is given with reference to an imaging system, it should be understood that system 500 could alternatively an interference optical system such as the system described in U.S. patent application Ser. No. 09/994,147, entitled “Interferometric Projection System” by Bloomstein, et al., the substance of said application is hereby incorporated by reference.

Final optic 504 is located close enough (e.g., 50 micrometers) to a surface of material 550 to allow index matching medium 530 to make optical contact with at least a portion of a final surface 505 of final optic 504, and a portion of the surface of material 550. A liquid handling system (not shown) may be added to contain index matching medium 530. In some embodiments, the liquid handling system provides an apparatus to replace index matching fluid 530 intermittently after a selected number of exposures. Alternatively a liquid handling system providing a continuous stream of index matching fluid 530 may be used.

It should be understood that in non-imaging systems, such as interference lithographic systems, final optic 504 may be a prism. As mentioned above, final optical 504 should have optical power; in an interference lithographic system, because of the discrete nature of the pattern forming light (i.e., the pattern forming light is comprised of two or more interfering beams), a prism provides the requisite optical power. In some embodiments, the prism has one surface normal to a first of the interfering beams, a second surface normal two a second of the interfering beam, and a flat final surface 505 having an angle with both the first surface and second surface. In some embodiments, the final surface 505 is parallel to a surface of material 550. The prism can be made from CaF₂ with n=1.57 at λ=157 nm, or another material transparent at the operational wavelength of system 500. Further details of interference lithographic systems are given in “Liquid Immersion deep-ultraviolet interfermetric lithography,” by Hofffiagle et al., published in The Journal of Vacuum Science and Technology B 17(6), November/December 1999, the substance of said article is hereby incorporated by reference.

Preferably, index matching medium 530 is reasonably closely index-matched to final optic 504. More preferably, the index of the index matching fluid is substantially the same as the final optic. In one embodiment of the invention, final optic 504 is made of CaF₂ having an index of 1.56 at a wavelength of 157 nm, and index matching medium 530 is made of PFPE having an index of 1.37-1.38 at a wavelength of 157 nm. If the index of index matching medium 530 is less than the index of final optic 504, the NA may be limited by total internal reflection at the interface of final optic 504 and index matching medium 530. Any index mismatch will contribute to decreased (and angularly-dependant) transmission of light, and increased scattering of light.

Also, index matching medium 530 preferably does not interact with material 550 in a manner that would impede image formation. For example, material 550 is not soluble in index matching medium 530, and index matching medium 530 does not chemically react with material 550 (e.g., in lithographic embodiments of the present invention, even part-per-billion levels of base in the immersion medium can prevent high resolution imaging in acid-catalyzed resists typically used at 193 and 157 nm). In some embodiments, it is preferable that index matching medium 530 is compatible with the cleanroom environment in which semiconductors are manufactured, as well as with other processes to which semiconductors are subjected.

Resists appropriate for use with lithographic embodiments of the present invention have appropriate photosensitivity at a selected operational wavelength. Resists preferably have an index of refraction that is insensitive to heat (e.g., heat arising from exposure to the operational wavelength of light) so as to prevent image distortion in the resist. In embodiments of the present invention operated at high NAs, resists preferably do not polarize light as a function of pupil position. Preferably, resists for use with lithographic embodiments of the present invention do not dissolve or chemically react with index matching medium 530 in the presence photons of the operative wavelength of light. Resists appropriate for use may be positive or negative chemically-amplified resists containing a protected polymer and a photoacid generator. Optionally, a base additive may be included.

One example of a resist appropriate for use with the present invention is a copolymer of p-hydroxystyrene and t-butyl acrylate. In some embodiments there is a monomer ratio of 60% p-hydroxystyrene and 40% t-butyl acrylate, and a photoacid generator of di-t-butylphenyl iodonium camphor sulfonate both in an ethyl lactate solvent. Optionally, a base additive of tetrabutyl amonium hydroxide may be included. In one embodiment, the copolymer, photoacid generator, base and solvent are mixed in a ratio of 94 parts, 6 parts, 1.2 parts, and 2757 parts respectively. Further details of resists appropriate for use with the present invention are given in U.S. Provisional patent application Ser. No. 09/851,952, filed May 9, 2001, entitled “Resists with Reduced Line Edge Roughness,” by T. Fedynyshyn.

Projection system 500 may be contained in a housing (not shown) which provides a mechanical base for the optical components. The housing may also be used to contain any inert gas used to purge the system of air (e.g., using N₂), as is the standard practice in lithographic systems operating at wavelengths below 650 nm. The housing may rest on translation and rotation stages (not shown) to align the system 500 with material 550. Further, the whole assembly may be supported by a vibration isolation system (not shown), as in conventional lithographic systems.

Some embodiments of lithographic systems according to the present invention are achieved by re-designing or converting a conventional “dry” (i.e., non-immersion) lithographic system for use as an immersion lithographic system, thus allowing many portions of conventional systems to be used to generate higher resolution. For example, projection systems and wafer handling portions of conventional lithographic systems may be modified to accommodate an index matching fluid. Accordingly, lithographic systems appropriate for use with index matching media include but are not limited to known lithographic systems, where an immersion medium is placed between the system and the substrate to be patterned, and the projection system has been modified using conventional optical design techniques to operate at an increased NA (e.g., an NA of 1.3 at 157 nm).

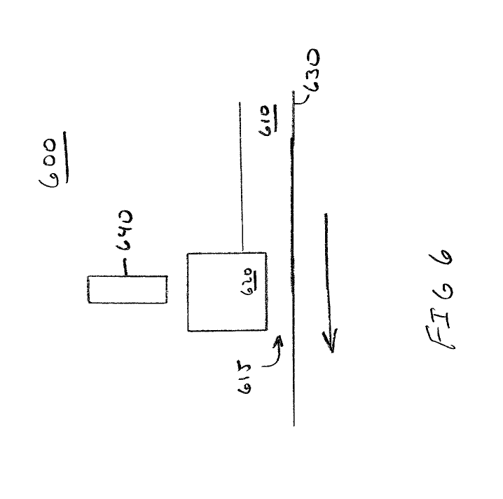

FIG. 6 is a schematic view of a system 600 for determining the ability of a given index matching medium to operate with a scanner lithographic system operating at a given scan speed. System 600 determines the ability of an index matching medium 610 to adequately fill a region 615 between a test final optic 620, and a moving test substrate 630. For example, referring to FIG. 5, in a lithographic system 500 which is a scanned lithographic system, the adequacy of a given index matching medium may be dependent on the ability of an index matching medium 530 to fill the space between the final optic 504 and substrate 550 at a given scanning speed. The ability of a given index matching medium to fill the space between the final optic 504 and substrate 550 for a given speed is at least partially dependent on the viscosity of the index matching medium.

Referring again to FIG. 6, test final optic 620 is maintained a selected distance (e.g., 100 micrometers) above moving test substrate 630, and a camera 640 is used to image a pattern formed on test substrate 630. By viewing the pattern through test final optical 620, it can be determined if index matching medium 610 uniformly fills space 615. Test final optic 620 may be selected to be a block optic which, because a block optic has relatively poor hydrodynamics, represents a worst case scenario. Accordingly, an index matching medium (e.g., a PFPE) found to perform adequately using a block optic will likely perform adequately with any other final optic (e.g., a substantially spherical optical).

Having thus described the inventive concepts and a number of exemplary embodiments, it will be apparent to those skilled in the art that the invention may be implemented in various ways, and that modifications and improvements will readily occur to such persons. Thus, the examples given are not intended to be limiting. The invention is limited only as required by the following claims and equivalents thereto.

What is claimed is:

1. An optical system for transmitting light, comprising:
an optical surface; and
a PFPE medium contacting at least a portion of the optical surface, the PFPE medium configured to transmit at least a portion of the transmitted light.

2. The optical system of claim 1, further comprising a second optical surface, the PFPE medium contacting at least a portion of the second optical surface.

3. The optical system of claim 1, wherein the optical system is a collection optical system.

4. The optical system of claim 1, wherein the optical system is a projection optical system.

5. An immersion lithographic system for projecting light having a wavelength less than 220 nanometers onto a resist covering at least a portion of a substrate, comprising:
an optical surface; and
an index matching medium contacting at least a portion of the optical surface, the index matching medium configured to transmit at least a portion of the light.

6. The immersion lithographic system of claim 5, wherein the index matching medium is characterized by a transmission of the light, and the transmission remains substantially constant during an exposure of a substrate.

7. The immersion lithographic system of claim 5, wherein the medium is substantially transparent to the light.

8. The immersion lithographic system of claim 5, wherein the medium is substantially transparent after a dose of approximately 10 J/cm².

9. The immersion lithographic system of claim 5, wherein the medium is a liquid.

10. The immersion lithographic system of claim 9, wherein the liquid is a PFPE.

11. The immersion lithographic system of claim 10, wherein the liquid is Fomblin Y®.

12. The immersion lithographic system of claim 10, wherein the liquid is Fomblin Z®.

13. A method of transmitting light, comprising an act of:
transmitting light through a PFPE medium.

14. The method of claim 13, wherein the light has a wavelength less than 220 nm.

15. The method of claim 13, further comprising transmitting the light through at least a portion of a first optical surface, wherein the first optical surface is in contact with the PFPE medium.

16. The method of claim 15, further comprising transmitting the light through at least a portion of a second optical surface, wherein the second optical surface is in contact with the PFPE medium.
